(19) United States
(12) Patent Application Publication
(10) Pub. No.: US 2025/0138826 A1
(43) Pub. Date: May 1, 2025

(54) Processor, Instruction Fetching Method, and Computer System

(71) Applicant: Beijing ESWIN Computing Technology Co., Ltd., Beijing City (CN)

(72) Inventors: Kunpeng Zhao, Beijing City (CN); Fei Gao, Beijing City (CN); Qi Wang, Beijing City (CN); Guohua Chen, Beijing City (CN)

(21) Appl. No.: 18/919,793

(22) Filed: Oct. 18, 2024

(30) Foreign Application Priority Data
Oct. 27, 2023 (CN) 202311413569.6

(51) Int. Cl. G06F 9/30; G06F 9/38

(52) U.S. Cl. CPC G06F 9/30065; G06F 9/3016; G06F 9/3802

(57) ABSTRACT

The present disclosure provides a processor, an instruction fetching method, and a computer system. The processor includes at least one processor core including an instruction fetch unit and a decoding unit; the instruction fetch unit is configured to perform detection of loop body flag instructions on acquired instructions; and send loop body instructions and non-loop body instructions in the acquired instructions to the decoding unit in a time-sharing manner according to a detection result, with the loop body flag instructions carrying a target number of loops of a loop body, and the instruction fetch unit cyclically sending the loop body instructions to the decoding unit according to the target number of loops; and the decoding unit is configured to decode received instructions.

### CROSS REFERENCE TO RELATED APPLICATIONS

This application claims priority to Chinese Patent Application No. 202311413569.6 filed Oct. 27, 2023, the disclosure of which is hereby incorporated by reference in its entirety.

### BACKGROUND OF THE INVENTION

### Field of the Invention

The present disclosure relates to the technical field of processors, and in particular, to a processor, an instruction fetching method, and a computer system.

### Description of Related Art

An instruction fetch unit (IFU) is a module for fetching instructions in a Central Processing Unit (CPU), and generally includes a cache memory (I-cache) and a function module related to branch prediction. Branch instructions are a type of necessary instructions in each of various instruction sets. Since the branch instructions may cause control risks, a pipeline may be refreshed when a processor executes the branch instructions. A proportion of the branch instructions in general program codes is about ¼, a designer subjects the branch instructions to special processing while designing the processor, and designs a branch prediction module to improve performance of the processor.

In an RISC-V instruction set, the branch instructions are mainly classified into two categories: conditional branch instructions and unconditional branch instructions. For a cyclic program segment, a predictor generally needs to learn for multiple times to accurately predict the cyclic program segment in a processor with a long pipeline, but cannot achieve precise prediction.

### SUMMARY OF THE INVENTION

In order to solve at least one of the technical problems in the prior art, the present disclosure provides a processor, an instruction fetching method, and a computer system.

In a first aspect, the present disclosure provides a processor, including: at least one processor core, wherein the at least one processor core includes: an instruction fetch unit and a decoding unit, the instruction fetch unit is configured to: perform detection of loop body flag instructions on acquired instructions; and send loop body instructions and non-loop body instructions in the acquired instructions to the decoding unit in a time-sharing manner according to a detection result, the loop body flag instructions carry a target number of loops of the loop body instructions, the instruction fetch unit cyclically sends the loop body instructions to the decoding unit according to the target number of loops, and the decoding unit is configured to decode received instructions.

In some embodiments, the instruction fetch unit includes: an instruction cache module, a detection module, a loop body cache module, and an instruction buffer queue module, the instruction cache module is configured to receive and cache the instructions; the detection module is configured to: acquire the instructions from the instruction cache module, and perform the detection of the loop body flag instructions on the acquired instructions; and send the loop body instructions to the loop body cache module and send the non-loop body instructions to the instruction buffer queue module, according to the detection result; the loop body cache module is configured to: cyclically send the loop body instructions to the decoding unit according to the target number of loops; and the instruction buffer queue module is configured to: send the non-loop body instructions in the instruction buffer queue module to the decoding unit when the loop body cache module stops sending the loop body instructions.

In some embodiments, the detection module includes a detection submodule and a sending submodule, the detection submodule is configured to: acquire the instructions from the instruction cache module, and detect whether the acquired instructions include a loop-body start flag instruction and a loop-body end flag instruction, and the sending submodule is configured to: send instructions starting from a next instruction immediately following the loop-body start flag instruction to the loop-body end flag instruction as the loop body instructions to the loop body cache module; and send remaining instructions as the non-loop body instructions to the instruction buffer queue module.

In some embodiments, the loop-body end flag instruction is: a conditional branch instruction which is located after the loop-body start flag instruction and has an offset which is a negative number.

In some embodiments, the loop body cache module is further configured to: when cyclically sending the loop body instructions to the decoding unit, reduce a current target number of loops by 1 after each time of sending of the loop body instructions is completed, and stop sending the loop body instructions when the current target number of loops is reduced to zero.

In some embodiments, the detection submodule is further configured to: detect the target number of loops carried in the loop-body start flag instruction, and send the target number of loops to the loop body cache module.

In some embodiments, the loop-body start flag instruction is a hint instruction.

In some embodiments, the instruction fetch unit further includes a branch predictor configured to predict a jump direction and a destination address of a branch instruction on a path between the detection module and the instruction buffer queue module.

In a second aspect, the present disclosure provides an instruction fetching method, including: performing detection of loop body flag instructions on received instructions; and sending loop body instructions and non-loop body instructions in the received instructions to a decoding unit in a time-sharing manner according to a detection result, so as to allow the decoding unit to decode the received instructions, wherein the loop body flag instructions carry a target number of loops of the loop body instructions, and the loop body instructions are cyclically sent to the decoding unit based on the target number of loops.

In a third aspect, the present disclosure provides a computer system, including the processor described above.

In some embodiments, the computer system further includes: a compiler configured to identify a code length of a loop body including loop body instructions; and send a loop body having a code length smaller than a preset length to the processor.

### BRIEF DESCRIPTION OF THE DRAWINGS

The drawings are intended to provide a further understanding of the present disclosure, constitute a part of the description, and are used to explain the present disclosure together with the following detail description of embodiments, but do not constitute any limitation to the present disclosure. In the drawings:

FIG. 1 is a system block diagram of a processor according to some embodiments of the present disclosure.

FIG. 2 is a schematic diagram of an instruction fetch unit and a decoding unit according to some embodiments of the present disclosure.

FIG. 3 is a schematic diagram of an instruction fetch unit and a decoding unit according to some embodiments of the present disclosure.

FIG. 4 is a schematic diagram of an instruction fetching method according to some embodiments of the present disclosure.

FIG. 5 is a schematic diagram of a computer system according to some embodiments of the present disclosure.

### DESCRIPTION OF THE INVENTION

The detail description of embodiments of the present disclosure are described in detail below with reference to the drawings. It should be understood that the detail description of embodiments described herein are only used to illustrate and explain the present disclosure, rather than limiting the present disclosure.

In order to make objectives, technical solutions and advantages of the embodiments of the present disclosure clearer, technical solutions of the embodiments of the present disclosure are clearly and thoroughly described below in conjunction with the drawings. Apparently, the embodiments described herein are merely some embodiments of the present disclosure, and do not cover all embodiments. All other embodiments derived by those of ordinary skill in the art from the described embodiments of the present disclosure without inventive work fall within the scope of the present disclosure.

Unless otherwise defined, technical terms or scientific terms used in the embodiments of the present disclosure should have general meanings that are understood by those of ordinary skill in the technical field of the present disclosure. Terms “first”, “second” and the like used herein do not denote any order, quantity or importance, but are just used to distinguish among different components.

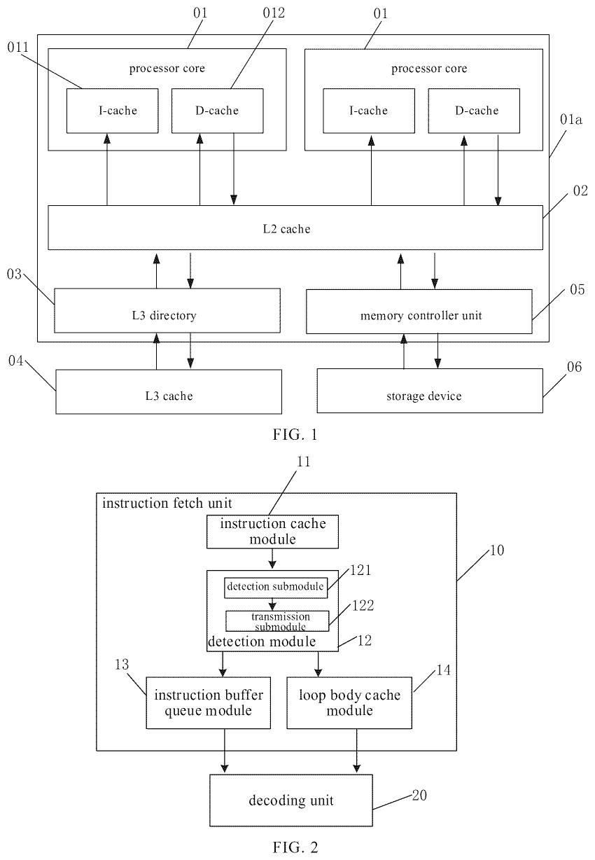

The embodiments of the present disclosure provide a processor, and FIG. 1 is a system block diagram of the processor according to some embodiments of the present disclosure.

As shown in FIG. 1, the processor may include a plurality of processor cores 01 and a memory controller unit 05. In some examples, the processor may be implemented as a CPU, and the processor cores 01 are general purpose cores, e.g., general-purpose ordered cores, general-purpose unordered cores, or a combination thereof. In some other examples, the processor cores 01 may be implemented as coprocessors, and are a plurality of special purpose cores for graphics and/or science (throughput). In some other examples, the processor may be implemented as a coprocessor, and the processor cores 01 are a plurality of general-purpose ordered cores.

A memory hierarchy includes a level-1 (L1) cache, a level-2 (L2) cache 02, and an external storage device 06. The L1 cache includes an instruction cache memory (I-cache) 011 and a data cache memory (D-cache) 012, which are in each processor core 01. The external storage device 06 is coupled to the memory controller unit 05. The processor cores 01, the L2 cache 02, a level-3 (L3) directory 03, and the memory control unit 05 are deployed in a processing chip 01a. The instruction cache memory 011 and the data cache memory 012 are coupled to the L2 cache 02. The L2 cache 02 operates as a memory cache, and is located outside the processor cores 01. The memory controller unit 05 is configured to manage data transmission between the L2 cache 02 and the external storage device 06. The processor further includes the L3 directory 03, which provides on-chip access to an off-chip L3 cache 04. The L3 cache 04 may be an additional dynamic random access memory.

In some embodiments, the processor includes an instruction fetch unit and a decoding unit (not shown), which may be deployed in a processor core 01.

The instruction fetch unit is configured to perform detection of loop body flag instructions on acquired instructions, and send loop body instructions and non-loop body instructions in the acquired instructions to the decoding unit in a time-sharing manner according to a detection result. The loop body flag instructions carry a target number of loops of the loop body instructions, and the instruction fetch unit cyclically sends the loop body instructions to the decoding unit according to the target number of loops, that is, repeatedly sends the loop body instructions to the decoding unit until the target number of loops is reached.

The instruction fetch unit may acquire the instructions to be processed from a memory or other sources, and send the acquired instructions to the decoding unit. The instructions acquired by the instruction fetch unit include, but are not limited to, advanced machine instructions or macro instructions. The processor performs specific functions by executing those instructions.

It should be noted that an instruction segment formed by a plurality of instructions often needs to be processed repeatedly in the processor, and the instruction segment is referred to as a loop body. The loop body instructions refer to instructions included in the loop body. The non-loop body instructions refer to instructions which do not belong to the loop body.

The loop body flag instructions refer to instructions capable of indicating a loop-body start position and a loop-body end position. In one example, the loop body flag instructions may include a loop-body start flag instruction and a loop-body end flag instruction. After performing the detection of the loop body flag instructions on the acquired instructions, the instruction fetch unit may determine whether the acquired instructions belong to the loop body.

The decoding unit is configured to: decode received instructions to generate a low-level micro-operation, a microcode entry point, a microinstruction, or other low-level instructions or control signals. The low-level instructions or control signals may implement operations of high-level instructions through low-level (e.g., circuit-level or hardware-level) operations. The decoding unit may be implemented with various mechanisms. Examples of suitable mechanisms include, but are not limited to, a microcode, a lookup table, a hardware implementation, and a Programmable Logic Array (PLA).

In the processor according to the embodiments of the present disclosure, the instruction fetch unit may perform the detection of the loop body flag instructions on the instructions, so that the instruction fetch unit may determine whether the instructions belong to the loop body according to the detection result, and cyclically send the loop body instructions to the decoding unit for decoding according to the target number of loops carried in the loop body flag instructions. The loop body flag instructions are the instructions for indicating the loop-body start position and the loop-body end position. For example, when the instructions include the loop-body start flag instruction, it is indicated that instructions starting from a next instruction immediately following the loop-body start flag instruction are the loop body instructions; and when the instructions include the loop-body end flag instruction, it is indicated that the loop body ends at the loop-body end flag instruction. Compared with a prediction method, the processor according to the embodiments of the present disclosure can accurately detect the loop body by performing the detection of the loop body flag instructions on the instructions, thereby improving performance of the processor.

FIG. 2 is a schematic diagram of an instruction fetch unit and a decoding unit according to some embodiments of the present disclosure.

As shown in FIG. 2, the instruction fetch unit 10 includes: an instruction cache module 11, a detection module 12, a loop body cache module 14, and an instruction buffer queue module 13.

The instruction cache module 11 is the instruction cache memory 011 described with reference to FIG. 1. The instruction cache module 11 is configured to receive and cache the instructions. The instructions received by the instruction cache module 11 are instructions sent to the instruction fetch unit 10 by a module (e.g., a compiler) outside the instruction fetch unit 10.

In some embodiments, the detection module 12 is configured to acquire the instructions from the instruction cache module 11, and perform the detection of the loop body flag instructions on the acquired instructions; and send the loop body instructions to the loop body cache module 14 and send the non-loop body instructions to the instruction buffer queue module 13, according to the detection result.

The loop body cache module 14 is configured to: cyclically send the loop body instructions to the decoding unit 20 according to the target number of loops of the loop body.

The instruction buffer queue module 13 is configured to send the non-loop body instructions therein to the decoding unit 20 when the loop body cache module 14 stops sending the loop body instructions. With the above sending manners of the loop body cache module 14 and the instruction buffer queue module 13, time-sharing sending of the loop body instructions and the non-loop body instructions can be realized.

In one example, the instruction fetch unit 10 may further include a selection module (not shown), the loop body cache module 14 may send the loop body instructions to the selection module, and the selection module sends the loop body instructions to the decoding unit 20 when receiving the loop body instructions sent from the loop body cache module 14. When the loop body cache module 14 stops sending the loop body instructions to the selection module, the selection module connects the instruction buffer queue module 13 with the decoding unit 20, so that the instruction buffer queue module 13 can send the non-loop body instructions to the decoding unit 20.

In some embodiments, the loop body flag instructions may include the loop-body start flag instruction and the loop-body end flag instruction. The loop-body start flag instruction indicates that the loop body is about to start, and the loop-body end flag instruction indicates an end of the loop body.

As shown in FIG. 2, the detection module 12 may include: a detection submodule 121 and a sending submodule 122.

The detection submodule 121 is configured to acquire the instructions from the instruction cache module 11, and detect whether the acquired instructions include the loop-body start flag instruction and the loop-body end flag instruction.

The detection submodule 121 determines the next instruction immediately following the loop-body start flag instruction as a first instruction of the loop body after detecting the loop-body start flag instruction, and determines that the loop body ends after detecting the loop-body end flag instruction.

The sending submodule 122 is configured to send instructions starting from the next instruction immediately following the loop-body start flag instruction to the loop-body end flag instruction as the loop body instructions to the loop body cache module 14; and send the remaining instructions as the non-loop body instructions to the instruction buffer queue module 13.

In some embodiments, the loop-body start flag instruction may be a hint instruction.

Hint instructions in an RISC-V instruction set are shown in Table 1.

TABLE 1

| instruction | | | |
|---|---|---|---|
| (hint instruction) | constraint | code point | purpose |
| C. NOP | Nzimm ≠ 0 | 63 | future |
| C. ADDI | rd ≠ x0, nzimm = 0 | 31 | standard use |
| C. LI | rd = x0 | 64 | |
| C. LUI | rd = x0, nzimm ≠ 0 | 63 | |
| C. MV | rd = x0, rs2 ≠ x0 | 31 | |
| C. ADD | rd = x0, rs2 ≠ x0 | 31 | |
| C. SLLI | rd = x0, nzimm ≠ 0 | 31 | customization |
| | | (RV32) | |
| | | 63 | |
| | | (RV64/128) | |
| C. SLLI64 | rd = x0 | 1 | |
| C. SLLI64 | rd ≠ x0, merely for | 31 | |
| | RV32 and RV64 | | |
| C. SRLI64 | merely for RV32 | 8 | |
| | and RV64 | | |
| C. SRAI64 | merely for RV32 | 8 | |
| | and RV64 | | |

In the C extension of the RISC-V instruction set, the hint instructions C.SLLI, C.SLLI64, C.SRLI64, and C.SRAI64 specified by the specification (spec) may be used for a user-defined loop-body start flag instruction. For a loop body in a high-level language program, the loop-body start flag instruction may be inserted before the loop body through identification and optimization of a program by a compiler.

In some embodiments, the loop-body start flag instruction carries the target number of loops. The detection submodule 121 is further configured to detect the target number of loops carried in the loop-body start flag instruction, and send the target number of loops to the loop body cache module 14. The compiler may generate the loop-body start flag instruction carrying the target number of loops according to a preset rule, and the detection submodule 121 acquires the target number of loops according to the preset rule after detecting the loop-body start flag instruction.

Instruction coding formats of C.SLLI and C.SLLI64 are shown in Table 2. For example, after identifying the loop body, the compiler writes the target number of loops of the loop body into a rs1/rd domain segment. After detecting the loop-body start flag instruction, the detection submodule 121 acquires a value written in the rs1/rd domain segment of the loop-body start flag instruction, that is, obtains the target number of loops. If the target number of loops cannot be effectively extracted, the rs1/rd domain segment is set to be all 1, i.e., Oxlf. In such case, the instruction fetch unit 10 may continuously and cyclically send the loop body instructions to the decoding unit 20, and a subsequent execution unit receives and executes the loop body instructions, and when the execution unit stops performing loops and jumps, the execution unit sends an end signal to the instruction fetch unit 10, and the instruction fetch unit 10 stops sending the instructions in response to the end signal.

TABLE 2

| 15 | 14 | 13 | 12 | 11 | 10 | 9 | 8 | 7 | 6 | 5 | 4 | 3 | 2 | 1 | 0 | |
|---|---|---|---|---|---|---|---|---|---|---|---|---|---|---|---|---|
| 000 | | | nzuimm[5] | rs1/rd ≠ 0 | | | | | nzuimm[4:0] | | | | | 10 | | C. SLLI [symbol] |
| 000 | | | 0 | rs1/rd ≠ 0 | | | | | 0 | | | | | 10 | | C. SLLI64 [symbol] |

[symbol]

indicates data missing or illegible when filed

In some embodiments, the loop-body end flag instruction is: a conditional branch instruction which is located after the loop-body start flag instruction and has an offset that is a negative number. That is, after the detection submodule 121 has detected the loop-body start flag instruction, if the detection submodule 121 detects that an instruction acquired from the instruction cache module 11 is the conditional branch instruction and the offset of the conditional branch instruction is the negative number, it indicates that the loop body ends. In other words, instructions starting from the next instruction immediately following the loop-body start flag instruction to the conditional branch instruction having the offset that is the negative number form one loop body.

In some embodiments, the loop body cache module 14 is specifically configured to: when cyclically sending the loop body instructions to the decoding unit 20, reduce a current target number of loops by 1 after each time of sending of the loop body instructions is completed, and stop sending the loop body instructions when the current target number of loops is reduced to zero, so that a number of times of decoding the loop body by the decoding unit 20 reaches the target number of loops. Specifically, the loop body cache module 14 may reduce the current target number of loops by 1 each time the conditional branch instruction having the offset that is the negative number is sent.

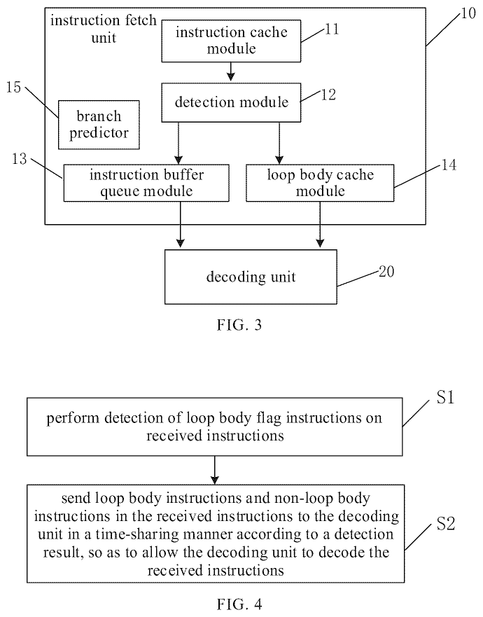

FIG. 3 is a schematic diagram of the instruction fetch unit 10 and the decoding unit 20 according to some embodiments of the present disclosure. The functions of the instruction cache module 11, the detection module 12, the instruction buffer queue module 13, and the loop body cache module 14 included in the instruction fetch unit 10 in FIG. 3 are the same as those described with reference to FIG. 2, and are not be repeated here.

As shown in FIG. 3, the instruction fetch unit 10 further includes a branch predictor 15, which is configured to predict a jump direction and a destination address of a branch instruction on a path between the detection module 12 and the instruction buffer queue module 13. It should be noted that the instructions in the instruction cache module 11 may include other branch instructions than the conditional branch instruction in the loop body. While being sent to the instruction buffer queue module 13 by the detection module 12, these branch instructions may be monitored by the branch predictor 15 for prediction of jump directions and destination addresses.

FIG. 4 is a schematic diagram of an instruction fetching method according to some embodiments of the present disclosure, and the instruction fetching method is applied to the processor described with reference to FIG. 1 to FIG. 3. As shown in FIG. 4, the instruction fetching method includes the following steps S1 and S2.

In step S1, the detection of the loop body flag instructions is performed on the received instructions.

In step S2, the loop body instructions and the non-loop body instructions in the received instructions are sent to the decoding unit in the time-sharing manner according to the detection result, so as to allow the decoding unit to decode the received instructions. The loop body flag instructions carry the target number of loops of the loop body instructions, and the loop body instructions are cyclically sent to the decoding unit based on the target number of loops.

Details of the steps S1 and S2 are described above with reference to FIG. 2 and FIG. 3, and are not repeated here.

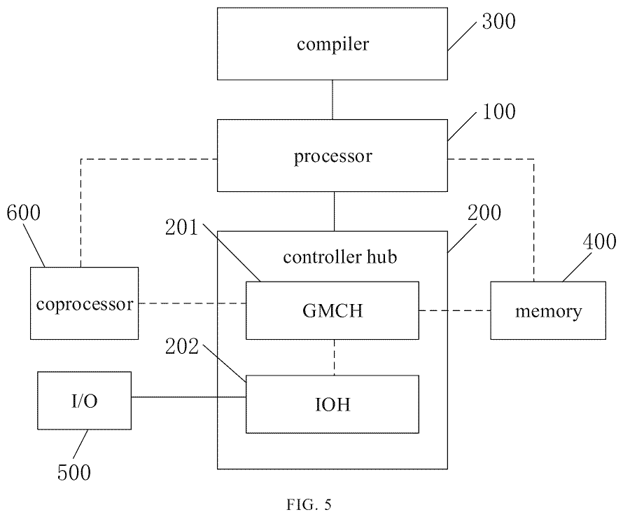

FIG. 5 is a schematic diagram of a computer system according to some embodiments of the present disclosure, and the computer system is applicable to a laptop, a desktop, a handheld PC, a personal digital assistant, an engineering workstation, a server, a network device, an embedded processor, a graphics device, a video game device, a microcontroller, a portable media player, a handheld device, and various other electronic devices, The present disclosure is not limited thereto, and all systems that may incorporate the processor and/or other execution logic disclosed in the description of the present disclosure are within the scope of the present disclosure.

As shown in FIG. 5, the computer system includes one or more processors 100 coupled to a controller hub 200. The processor 100 is the processor described with reference to FIG. 1 to FIG. 3. In one embodiment, the controller hub 200 includes a Graphics and Memory Controller Hub (GMCH) 201 and an Input/Output Hub (IOH) 202, which may be deployed on separate chips. The GMCH 201 includes a memory controller and a graphics controller, which are coupled to a memory 400 and a coprocessor 600. The IOH 202 couples an input/output device 500 (I/O device) to the GMCH 201.

The memory 400 may be, for example, a Dynamic Random Access Memory (DRAM), a Phase-Change Memory (PCM), or a combination thereof. The coprocessor 600 is a special purpose processor, such as a high-throughput Many Integrated Core (MIC) processor, a network or communication processor, a compression engine, a graphics processor, a General-Purpose Graphics Processing Unit (GPGPU), an embedded processor, or the like. In one embodiment, the controller hub 200 may include an integrated graphics accelerator.

The computer system further includes a compiler 300, which is configured to identify a code length (i.e., a numbers of bytes) of a loop body (i.e., loop body instructions included in the loop body), insert the loop-body start flag instruction before the loop body having a code length smaller than a preset length, and send the loop-body start flag instruction and the loop body to the instruction fetch unit 10 in the processor.

That is, the loop body sent to the loop body cache module 14 by the detection module 12 described with reference to FIG. 2 and FIG. 3 is the loop body having the code length smaller than the preset length. The compiler 300 does not insert the loop-body start flag instructions to a loop body having a code length greater than or equal to the preset length, in which case the detection module 12 does not detect the loop body having the code length greater than or equal to the preset length, so that the detection module 12 sends the loop body having the code length greater than or equal to the preset length to the instruction buffer queue module 13.

The preset length may be set according to actual hardware resources.

Instructions of one loop body are listed below. A loop-body start flag instruction “li, t0, 0x10” is inserted before the loop body, and indicates that the target number of loops is 10. After extracting the target number of loops, the compiler 300 inserts the loop-body start flag instruction before the loop body. Specifically, the compiler 300 inserts the loop-body start flag instruction, which carries the target number of loops, before the instruction “ld t1, 0 (s1)”.
li, t0, 0x10.
loop:
1d t1, 0 (s1)
add t2, t2, t1
addi s1, s1, 0x8
subi t0, t0, 0x1
c. bnez to, loop

When the detection submodule 121 described with reference to FIG. 2 receives the loop-body start flag instruction, the detection submodule 121 acquires the target number of loops carried therein, and sends the target number of loops to the loop body cache module 14. The instructions following the loop-body start flag instruction are sequentially sent to the loop body cache module 14 until a loop-body end flag instruction “c.bnez to, loop” is sent, and the loop body is repeatedly sent until the target number of loops is reached.

In the embodiments of the present disclosure, the instruction fetch unit 10 can accurately detect the loop body according to the loop body flag instructions without contaminating the predictor, thereby improving the performance of the processor.

It should be understood that the above implementations are merely exemplary implementations adopted to illustrate the principle of the present application, and the present application is not limited thereto. Without departing from the spirit and essence of the present application, those of ordinary skill in the art may make various modifications and improvements to the present disclosure, and those modifications and improvements should be considered to fall within the scope of the present disclosure.

What is claimed is:

1. A processor, comprising:
at least one processor core,
wherein the at least one processor core comprises: an instruction fetch unit and a decoding unit,
the instruction fetch unit is configured to: perform detection of loop body flag instructions on acquired instructions; and send loop body instructions and non-loop body instructions in the acquired instructions to the decoding unit in a time-sharing manner according to a detection result,
the loop body flag instructions carry a target number of loops of the loop body instructions, and the instruction fetch unit cyclically sends the loop body instructions to the decoding unit according to the target number of loops, and
the decoding unit is configured to decode received instructions.

2. The processor of claim 1, wherein the instruction fetch unit comprises: an instruction cache module, a detection module, a loop body cache module, and an instruction buffer queue module,
the instruction cache module is configured to receive and cache the instructions;
the detection module is configured to: acquire the instructions from the instruction cache module, and perform the detection of the loop body flag instructions on the acquired instructions; and send the loop body instructions to the loop body cache module and send the non-loop body instructions to the instruction buffer queue module, according to the detection result;
the loop body cache module is configured to: cyclically send the loop body instructions to the decoding unit according to the target number of loops; and
the instruction buffer queue module is configured to: send the non-loop body instructions in the instruction buffer queue module to the decoding unit when the loop body cache module stops sending the loop body instructions.

3. The processor of claim 2, wherein the detection module comprises a detection submodule and a sending submodule,
the detection submodule is configured to: acquire the instructions from the instruction cache module, and detect whether the acquired instructions comprise a loop-body start flag instruction and a loop-body end flag instruction, and
the sending submodule is configured to: send instructions starting from a next instruction immediately following the loop-body start flag instruction to the loop-body end flag instruction as the loop body instructions to the loop body cache module; and send remaining instructions as the non-loop body instructions to the instruction buffer queue module.

4. The processor of claim 3, wherein the loop-body end flag instruction is a conditional branch instruction which is located after the loop-body start flag instruction and has an offset which is a negative number.

5. The processor of claim 4, wherein the loop body cache module is further configured to: when cyclically sending the loop body instructions to the decoding unit, reduce a current target number of loops by 1 after each time of sending of the loop body instructions is completed, and stop sending the loop body instructions when the current target number of loops is reduced to zero.

6. The processor of claim 3, wherein the detection submodule is further configured to: detect the target number of loops carried in the loop-body start flag instruction, and send the target number of loops to the loop body cache module.

7. The processor of claim 3, wherein the loop-body start flag instruction is a hint instruction.

8. The processor of claim 2, wherein the instruction fetch unit further comprises a branch predictor configured to predict a jump direction and a destination address of a branch instruction on a path between the detection module and the instruction buffer queue module.

9. An instruction fetching method, comprising:
performing detection of loop body flag instructions on received instructions; and
sending loop body instructions and non-loop body instructions in the received instructions to a decoding unit in a time-sharing manner according to a detection result, so as to allow the decoding unit to decode the received instructions,
wherein the loop body flag instructions carry a target number of loops of the loop body instructions, and the loop body instructions are cyclically sent to the decoding unit based on the target number of loops.

10. A computer system, comprising the processor of claim 1.

11. The computer system of claim 10, further comprising:
a compiler configured to identify a code length of a loop body comprising loop body instructions; and send a loop body having a code length smaller than a preset length to the processor.
